(19) United States
(12) Patent Application Publication
(10) Pub. No.: US 2008/0078112 A1
(43) Pub. Date: Apr. 3, 2008

(54) Sign assembly with clearance indicator

(75) Inventor: Ismael Basha, Troy, MI (US)

Correspondence Address: HARNESS, DICKEY & PIERCE, P.L.C., P.O. BOX 828, BLOOMFIELD HILLS, MI, 48303, US

(73) Assignee: TSS, Inc.

(21) Appl. No.: 11/518,601

(22) Filed: Sep. 8, 2006

(51) Int. Cl. G09F 15/00

(52) U.S. Cl. 40/606.15

(57) ABSTRACT

A sign assembly may include a display portion and an arm extending from the display portion. The arm may be moveable from an at-rest position, through a warning stroke in a first direction upon engagement with a vehicle to a fully extended position at an end of the warning stroke. An arm retraction mechanism may cooperate with the arm so as to provide a resistance force toward the at-rest position upon vehicle engagement while the arm is moving through the warning stroke. The retraction mechanism may be further adapted to return the arm to the at-rest position upon disengagement with the vehicle.

### FIELD

This invention relates generally to signs and, more particularly, to a sign assembly indicating a clearance for a vehicle.

### BACKGROUND

Signs may be used in many applications to enhance a particular portion of the sign assembly or to improve the visual presentation of the sign assembly as a whole. For example, many businesses utilize various display signs to draw the attention of a perspective customer. One common strategy is to adapt various lighting configurations within the sign assembly. For example, some sign assemblies have displays that illuminate and/or flash.

In one particular application it may be desirable to provide a vertical clearance indication to a driver. For example, it may be desirable to notify a driver of a vertical clearance limit such as in a car wash, parking ramp, tunnel, drive-thru restaurant or other limited clearance applications.

In some applications, however, it may be more challenging to adapt an illuminated sign and a clearance indicator for use in an unfavorable environment. For example, in wet or damp environments such as in and around a car wash, the environment may be particularly harmful to electronics and mechanical devices. In this way, over time, such illuminated displays and/or mechanical devices may become corroded and, in some cases, inoperable. It would be desirable to provide an illuminated sign and clearance indicator that is cost effective to manufacture and provides improved visual stimulation and operation.

### SUMMARY

A sign assembly may include a display portion and an arm extending from the display portion. The arm may be moveable from an at-rest position, through a warning stroke in a first direction upon engagement with a vehicle to a fully extended position at an end of the warning stroke. An arm retraction mechanism may cooperate with the arm so as to provide a resistance force toward the at-rest position upon vehicle engagement while the arm is moving through the warning stroke. The retraction mechanism may be further adapted to return the arm to the at-rest position upon disengagement with the vehicle.

According to additional features, the arm may define a longitudinal body portion having a proximal end adjacent the display portion and an opposite distal end. The longitudinal body portion may define a first axis substantially parallel to ground. The arm retraction mechanism may include a brace fixedly disposed on the display portion. The brace may define a body portion and be connected to the arm at the pivot joint. The pivot joint may define a pivot axis substantially perpendicular to the first axis. According to one example, the retraction mechanism may include a biasing member connected between the distal and proximal ends of the arm. The biasing member may be connected to the proximal end of the arm by way of a cable extending between the biasing member on one end and the proximal end of the arm on an opposite end.

According to other features, the retraction mechanism may also include a first pulley disposed on the brace and cooperating with the cable upon movement of the arm through the warning stroke. A second pulley may be interconnected to the arm and cooperating with the cable upon movement of the arm through the warning stroke. In one example, the arm may define a C-channel geometry that accommodates the brace within the C-channel in the at-rest position.

Further areas of applicability of the present disclosure will become apparent from the detailed description provided hereinafter. It should be understood that the detailed description and various examples, while indicating various embodiments of the invention, are intended for purposes of illustration only and are not intended to limit the scope of the following claims.

### BRIEF DESCRIPTION OF THE FIGURES

The present invention will become more fully understood from the detailed description and the accompanying drawings, wherein:

FIG. 1 is a front perspective view of a sign assembly according to the present teachings;

FIG. 2 is a front perspective view of the sign assembly shown with the clearance arm initially rotated around a pivot axis;

FIG. 3 is a front perspective view of the sign assembly shown with the clearance arm further rotated around the pivot axis;

FIG. 4 is a front exploded view of the clearance arm and retraction assembly of the sign assembly according to the present teachings; and

FIG. 5 is a rear perspective view of the clearance arm and retraction assembly.

### DETAILED DESCRIPTION OF VARIOUS EMBODIMENTS

The following description of various embodiment(s) is merely exemplary in nature and is in no way intended to limit the application or uses.

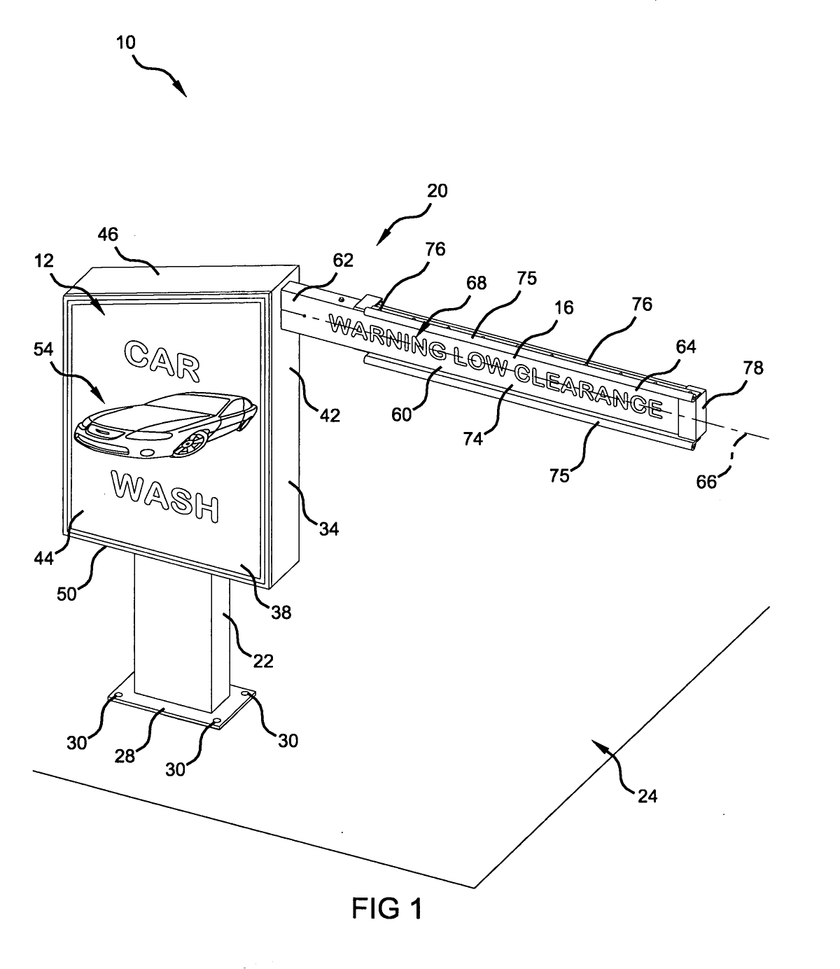

With initial reference to FIG. 1, a sign assembly according to the present teachings is shown and generally identified at reference numeral 10. The sign assembly 10 generally includes a display portion 12, a clearance arm 16 and an arm retraction mechanism 20. The sign assembly 10 is adaptable to provide the display portion 12 for conveying a message and the clearance arm 16 for warning a driver. The display portion 12 may include a stand 22 operable to present the display portion 12 at a raised position relative to the ground 24. The stand 22 may include a ground platform 28 adapted to gain a stable footprint. The ground platform 28 may also include passages 30 for accepting fasteners (not shown) to mount the sign assembly 10 into a stable structure. It is appreciated that the display portion 12 may be configured differently, such as extending from an adjacent wall or directly mounted to the ground. The clearance arm 16 is operable to provide an audible warning, such as by vehicle impact, that the vertical clearance limit of a vehicle has been exceeded. It is appreciated that a vehicle operator may also be warned visually.

As will become appreciated throughout the present disclosure, the sign assembly 10 may be particularly useful in the car wash industry. The durable configuration of the sign assembly 10, as a whole and specifically the display portion 12, the clearance arm 16 and the arm retraction mechanism 20, is suitable for use in less than desirable environments, such as in and around car washes. Such environments may have high levels of moisture, humidity, salt, dirt, and other elements generally undesirable for electronic and/or mechanical components. Those skilled in the art will appreciate, however, that the sign assembly 10 is not limited to application in the car wash industry. In this regard, the sign assembly 10 may be used in other applications and environments, such as for parking garages, tunnels and other low clearance applications.

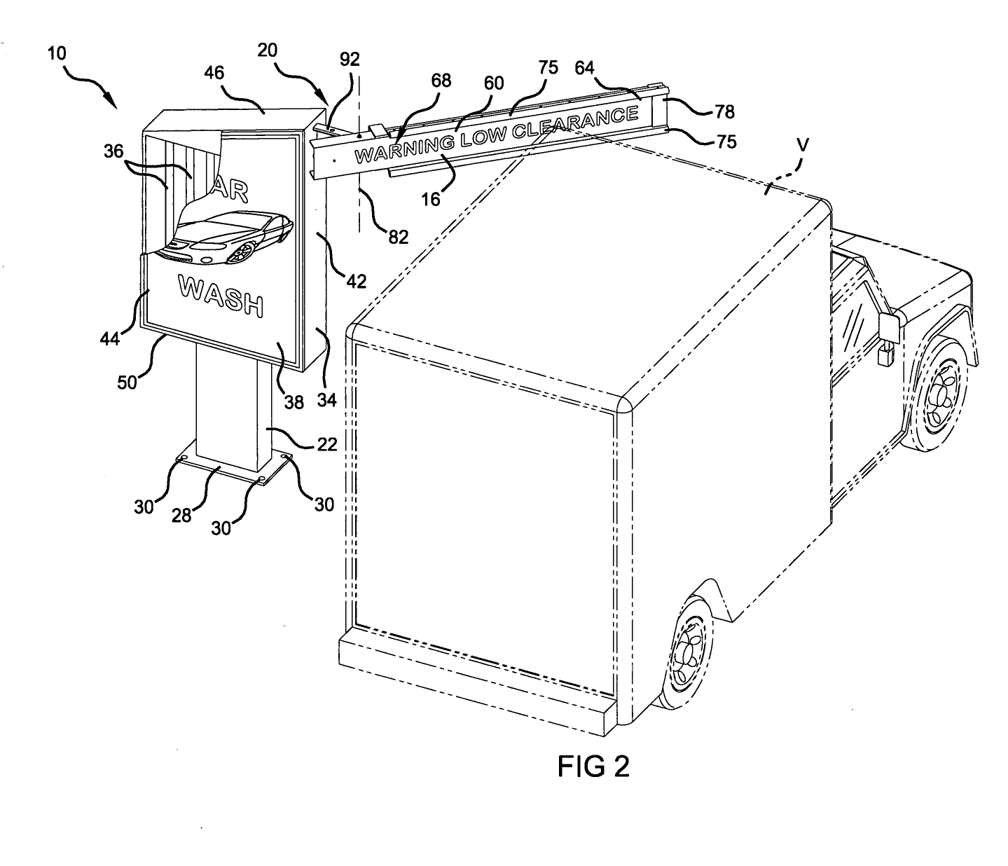

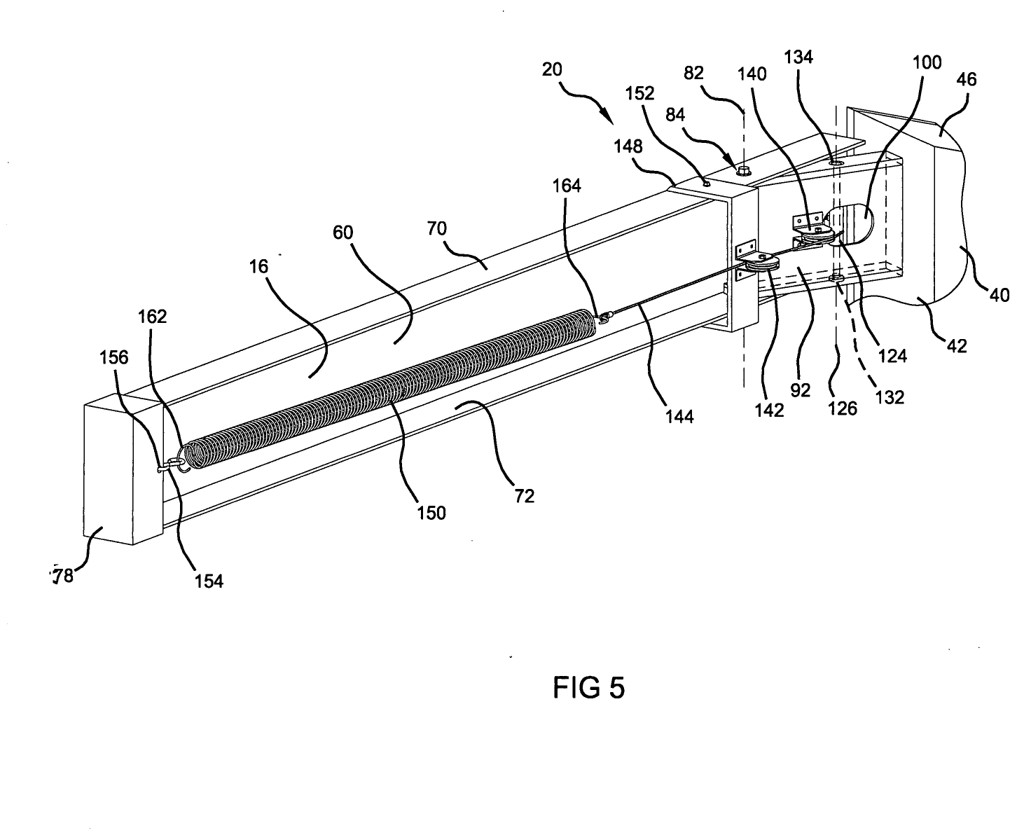

In one example, the display portion 12 may define a housing 34 including a light source 36 (as shown in FIG. 2). The housing 34 may be further defined by a front panel 38, a rear panel 40 (FIG. 5), side panels 42 and 44, an upper panel 46, and a lower panel 50. The light source 36 may comprise various ballasts for cooperating with various light emitting devices. By way of example, fluorescent tubing (such as normal output or very high output (VHO) fluorescent tubing, metal halide bulbs, light emitting diodes (LED's), halogen bulbs and others) are contemplated by the present teachings. The front panel 38 of the housing 34 may include semi-transparent material suitable to pass light therethrough. As shown, the semi-transparent material may further include a graphic 54 disposed thereon.

With continued reference to FIG. 1 and further reference to FIGS. 2-5, the clearance arm 16 will be described in greater detail. The arm 16 may generally define a longitudinal body portion 60 having a proximal end 62 adjacent the display portion 12 and an opposite distal end 64. The longitudinal body portion 60 defines a first axis 66 substantially parallel to the ground 24. The arm 16 may include a warning message 68. The warning message 68 such as “WARNING LOW CLEARANCE” is merely exemplary and may comprise other messages. In one example, the arm 16 may be formed of a non-compliant material, such as, but not limited to, metal. Exemplary materials may include stainless steel, aluminum and others. In the example shown, the arm 16 defines a C-section body having opposing upper and lower sides 70 and 72, respectively, connected by a front face 74 (FIG. 5).

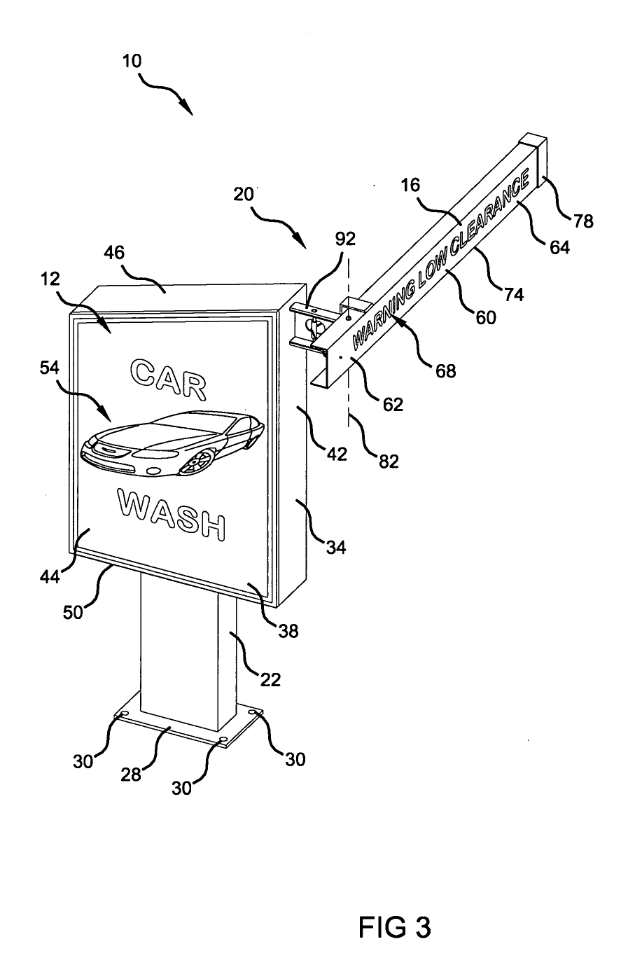

In one example, bumpers 75 may be optionally disposed on at least one of the upper and lower sides 70 and 72, respectively. The bumpers 75 may be secured by any suitable method such as by way of fasteners 76 extending through anchoring holes 77 and complementary holes formed in the clearance arm 16. The bumpers 77 may be attached to the clearance arm such that they overhang a distance from the front face 74. By way of example, the bumpers 75 may overhang about 1 or 2 inches from the front face 74. The bumpers 77 may be formed of resilient material such as rubber for example. The bumpers 77 are operable to absorb at least a portion of an impact force from a vehicle. For clarity, the bumpers 77 are not shown in FIGS. 3 and 5.

A cap 78 may be suitably affixed to the distal end 64. A pair of opposing apertures 80 may be defined through the opposing upper and lower sides 70, 72 and adapted to define a pivot axis 82 for accommodating a pivot joint 84, as will be described in greater detail. The pivot axis 82 may be substantially perpendicular to the first axis 66 of the longitudinal body portion 60. Further, as illustrated most clearly in FIG. 3, the pivot axis 82 is laterally offset from the side 42 of the display portion 12. By locating the pivot axis 82 at a laterally offset location relative to the side 42 (as opposed to collinear with the side 42), the moment arm of the pivot joint is reduced thus providing a more robust arrangement. An aperture 86 is also formed through the front face 74 for accepting a connecting member or hook 90, as will be described.

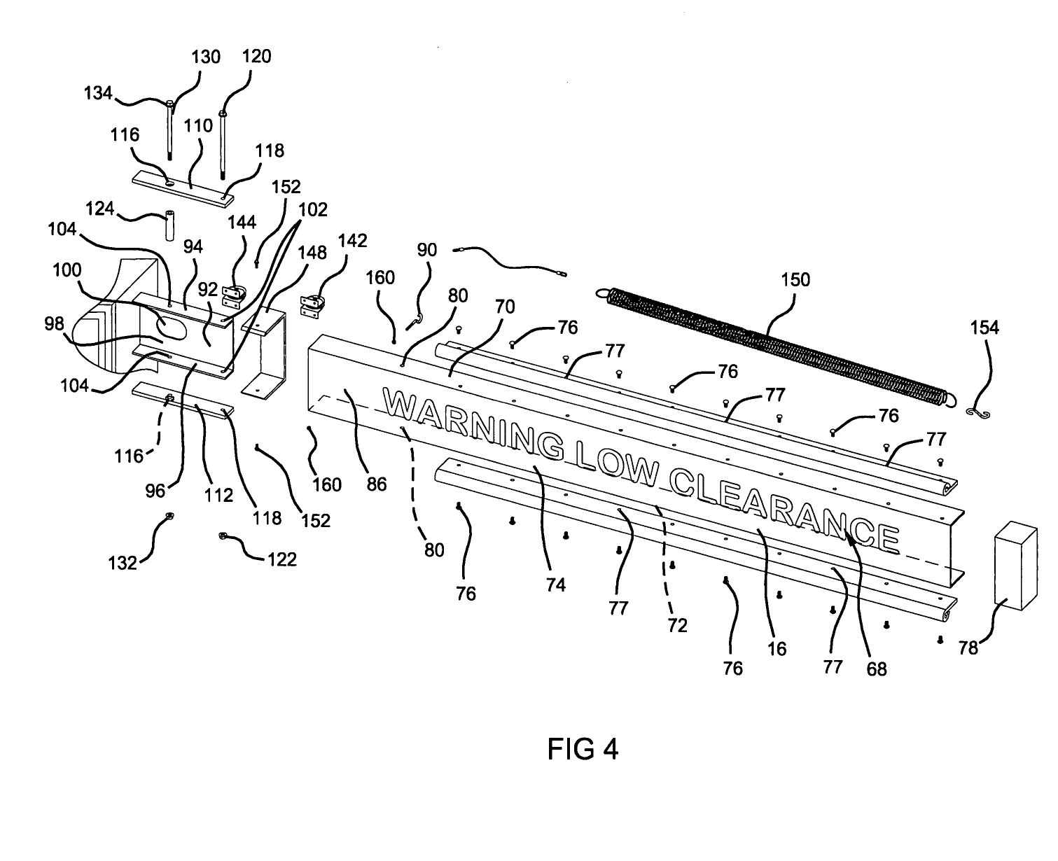

With particular reference now to FIGS. 3-5, the arm retraction mechanism 20 will be described in greater detail. The arm retraction mechanism 20 may generally include a brace 92 fixedly attached to the display portion 12. In one example, the brace 92 may extend from an upper portion of the side panel 42. The brace 92 may define a C-channel body having opposing upper and lower sides 94 and 96, respectively, connected by an intermediate panel 98 (FIG. 4). The intermediate panel 98 may define an opening 100. The upper and lower sides 94 and 96 may define a first and second pair of opposing passages 102 and 104, respectively. The first pair of opposing passages 102 may align with the pair of apertures 80 on the arm 16 along the pivot axis 82.

With particular reference to FIG. 4, an upper and lower support panel 110 and 112 may be securably mounted at the upper and lower sides 94 and 96 of the brace 92. The upper and lower support panels 110 and 112, respectively, may each define a support hole 116 and a pivot axis hole 118.

A pivot pin 120 may pass through the respective pivot axis holes of the support panels 110 and 112 and the first pair of passages 102 and mate with a nut 122 to define the pivot joint. The second pair of opposing passages 104 may be adapted to support a roller 124 along a support axis 126 (FIG. 5). In one example, a fastener 130 may extend through the second pair of passages 104 and through the roller 124 and securably mate with the nut 132. As best illustrated in FIG. 5, a faster head 134 of the fastener 130 and the nut 132 nest within the support holes 116 and defined on the support panels 110 and 112 so as not to interfere with the arm 16 during use.

With reference now to FIGS. 4 and 5, the arm retraction mechanism 20 may further include a first and second pulley 140, 142 adapted to cooperate with a cable 144. The first pulley 140 may be disposed on a rear portion of the brace 92. The second pulley 142 may be disposed on a bracket 148 arranged on the arm 16. The bracket 148 may be fixed to the arm 16 by any suitable method such as by screws 152.

A biasing member 150 may be connected between the distal and proximal ends 64 and 62, respectively, of the arm 16. More specifically, the biasing member 150 may be connected to the proximal end 62 of the arm 16 through the cable 144 and connected to the distal end 64 of the arm 16 at the cap 78. In one example, an S-hook 154 (or other connection member) may be suitably affixed through an eyelet 156 formed on the cap 78 and the hook 90 is threadably coupled to a nut 160 on the arm 16 (FIG. 4). A first end 162 of the biasing member 150 is coupled to the S-hook 154 and a second end 164 of the biasing member 150 is coupled to the hook 90. As best illustrated in FIG. 5, the cable 144 passes around an outboard portion of the first pulley 140 and an inboard portion of the second pulley 142.

Operation of the arm 16 and arm retraction mechanism 20 will now be described in greater detail. The arm retraction mechanism 20 cooperates with the arm 16 so as to provide a resistance force (provided by the biasing member 160) toward an at-rest position (FIG. 1) upon vehicle engagement with the arm 16. As illustrated in FIG. 2, a vehicle V is shown engaging the clearance arm 60. While a box-like truck is shown, it is appreciated that the sign assembly 10 and more specifically the arm 16 are adapted to function upon engagement with any type of vehicle. It is appreciated also, that items secured to an upper portion of a vehicle such as bikes or other equipment attached to a luggage rack or the like, are considered as part of the vehicle. As such, items stored atop of a vehicle may likewise engage the arm 60 and alert a driver of a clearance problem.

The arm 16 is adapted to pivot about the pivot axis 82 through a warning stroke. More specifically, the arm 16 is adapted to pivot from the at-rest position (FIG. 1) in a counter-clockwise direction (as viewed from above) around the pivot axis 82 to a fully extended position (FIG. 3). During such counter-clockwise rotation, the biasing member 150 is spread out upon the cable 144 rolling along the pulleys 140 and 142 and roller 124. As the biasing member 150 spreads out, a biasing force is generated that tends to pull the arm 16 in a clockwise direction (as viewed from above). Once the vehicle V is moved away from engagement with the arm 16, the biasing member 150 urges the arm back to the at-rest position (FIG. 1). It is appreciated that other biasing configurations may be adapted for use between the arm 16 and the display portion 12 and/or brace 92 for returning the arm 16 to the at-rest position.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A sign assembly comprising:
a display portion;
an arm extending from the display portion and moveable from an at-rest position, through a warning stroke in a first direction upon engagement with a vehicle to a fully extended position at an end of the warning stroke; and
an arm retraction mechanism that cooperates with the arm so as to provide a resistance force toward the at-rest position upon vehicle engagement while the arm is moving through the warning stroke, the retraction mechanism further adapted to return the arm to the at-rest position upon disengagement with the vehicle.

2. The sign assembly of claim 1 wherein the arm defines a longitudinal body portion having a proximal end adjacent the display portion and an opposite distal end, the longitudinal body portion defining a first axis substantially parallel to ground.

3. The sign assembly of claim 2 wherein the arm retraction mechanism includes a brace fixedly disposed on the display portion the brace defining a body portion and connected to the arm at a pivot joint.

4. The sign assembly of claim 2 wherein the pivot joint defines a pivot axis substantially perpendicular to the first axis.

5. The sign assembly of claim 3 wherein the retraction mechanism includes a biasing member connected between the distal and proximal ends of the arm.

6. The sign assembly of claim 5 wherein the biasing member is connected to the proximal end of the arm by way of a cable extending between the biasing member on one end and the proximal end of the arm on an opposite end.

7. The sign assembly of claim 6 wherein the retraction mechanism further includes a first pulley disposed on the brace and cooperating with the cable upon movement of the arm through the warning stroke.

8. The sign assembly of claim 8 wherein the retraction mechanism further includes a second pulley interconnected to the arm and cooperating with the cable upon movement of the arm through the warning stroke.

9. The sign assembly of claim 4 wherein the arm defines a C-channel geometry and wherein the brace is accommodated within the C-channel in the at-rest position.

10. The sign assembly of claim 9 wherein the pivot axis is laterally offset from the display portion.

11. A sign assembly comprising:
a display portion having an illuminated main body portion extending from a stand, the stand operable to present the display portion at a raised position relative to ground;
a non-compliant arm extending from an upper portion of the display portion and moveable from an at-rest position, through a warning stroke in a first direction upon engagement with a vehicle to a fully extended position at an end of the warning stroke; and
an arm retraction mechanism that cooperates with the arm so as to provide a resistance force toward the at-rest position upon vehicle engagement while the arm is moving through the warning stroke, the retraction mechanism further adapted to return the arm to the at-rest position upon disengagement with the vehicle.

12. The sign assembly of claim 11 wherein the arm defines a longitudinal body portion having a proximal end adjacent the display portion and an opposite distal end, the longitudinal body portion defining a first axis substantially parallel to ground.

13. The sign assembly of claim 12 wherein the arm retraction mechanism includes a brace fixedly disposed on the display portion the brace defining a body portion and connected to the arm at a pivot joint, wherein the pivot joint defines a pivot axis substantially perpendicular to the first axis.

14. The sign assembly of claim 12 wherein the retraction mechanism includes a biasing member connected between the distal and proximal ends of the arm, wherein the biasing member is connected to the proximal end of the arm by way of a cable extending between the biasing member on one end and the proximal end of the arm on an opposite end.

15. The sign assembly of claim 14 wherein the retraction mechanism further includes a first pulley disposed on the brace and a second pulley interconnected to the arm, the first and second pulleys cooperating with the cable upon movement of the arm through the warning stroke.

16. The sign assembly of claim 11, further comprising at least one bumper formed of resilient material disposed along the arm and adapted to extend outward beyond a front face of the arm to engage a vehicle upon impact.

17. The sign assembly of claim 11 wherein the arm defines a C-channel geometry and wherein the brace is accommodated within the C-channel in the at-rest position.

18. The sign assembly of claim 13 wherein the pivot axis is laterally offset from the display portion.

19. A sign assembly comprising:
a display portion having an illuminated main body portion extending from a stand, the stand operable to present the display portion at a raised position relative to ground;
a brace fixedly arranged on the display portion;
a non-compliant arm pivotally connected to the brace at a pivot joint, the non-compliant arm extending from an upper portion of the display portion and pivotal about a pivot joint from an at-rest position, through a warning stroke in a first direction upon engagement with a vehicle to a fully extended position at an end of the warning stroke; and
an arm retraction mechanism that cooperates with the arm so as to provide a resistance force toward the at-rest position upon vehicle engagement while the arm is moving through the warning stroke, the retraction mechanism further adapted to return the arm to the at-rest position upon disengagement with the vehicle.

20. The sign assembly of claim 19 wherein the non-compliant arm defines a C-channel, and wherein the brace nests within the C-channel in the at-rest position.
